(19) United States
(12) Patent Application Publication
(10) Pub. No.: US 2024/0057052 A1
(43) Pub. Date: Feb. 15, 2024

(54) A METHOD FOR TRANSMISSION OF SSB, A METHOD FOR OBTAINING SSB, A RELATED NETWORK NODE AND A RELATED WIRELESS DEVICE

(71) Applicant: Sony Group Corporation, Tokyo (JP)

(72) Inventors: Kun ZHAO, Malmö (SE); Erik Lennart BENGTSSON, Eslöv (SE); Olof ZANDER, Södra Sandby (SE); Fredrik RUSEK, Eslöv (SE); Jose FLORDELIS, Lund (SE)

(21) Appl. No.: 18/270,525

(22) PCT Filed: Dec. 15, 2021
(86) PCT No.: PCT/EP2021/085964

§ 371 Date: Jun. 30, 2023

(30) Foreign Application Priority Data
Jan. 15, 2021 (SE) 2150031-9

(51) Int. Cl. H04W 72/0453

(52) U.S. Cl. CPC H04W 72/0453

(57) ABSTRACT

A method is disclosed, performed by a network node, for transmission of a number of Synchronization Signal Blocks, SSBs, over a number of frequency resources to one or more wireless devices. Each SSB is associated with a corresponding beam. The method comprises broadcasting the SSBs according to a periodic sequence of frequency allocations for transmission of SSBs. The periodic sequence has a period where a first frequency resource is allocated to a first SSB and a second frequency resource is allocated to a second SSB, wherein the second frequency resource and the first frequency resource are different.

The present disclosure pertains to the field of wireless communications. The present disclosure relates to a method for transmission of Synchronization Signal Blocks (SSBs) over a number of frequency resources in an SSB burst transmission to one or more wireless devices, a method for obtaining a number of SSBs and related devices, such as a related network node and a related wireless device.

### BACKGROUND

The 3^{rd} Generation Partnership Project (3GPP) considers New Radio (NR) for unlicensed 52+ GHz bands, such as unlicensed frequency bands above 52 GHz. Transmission of Synchronization Signal Blocks (SSBs) needs to adapt to the unlicensed frequency bands above 52 GHz. In order to transmit an SSB burst, it may be mandatory from regulatory constraints in the unlicensed frequency bands to perform a Clear Channel Assessment (CCA) procedure, such as a Listen Before Talk (LBT) procedure, for each SSB. Only SSBs for which the CCA is successful may be transmitted.

If the network node (such as a gNB) transmits its SSB burst at a fixed frequency location, problems may arise due to an increase in traffic at said frequency over time, which results in the CCA procedures failing unacceptably often.

### SUMMARY

It is apparent that Synchronization Signal Blocks (SSBs) can play an important role in unlicensed bands. Accordingly, there is a need for devices and methods for transmission of a number of SSBs over a number of frequency resources, which mitigate, alleviate or address the shortcomings existing and provide a more robust SSB transmission.

A method is disclosed, performed by a network node, for transmission of a number of SSBs over a number of frequency resources to one or more wireless devices. Each SSB is associated with a corresponding beam. The method comprises broadcasting the SSBs according to a periodic sequence of frequency allocations for transmission of SSBs. The periodic sequence has a period where a first frequency resource is allocated to a first SSB and a second frequency resource is allocated to a second SSB. The second frequency resource and the first frequency resource are different.

Further, a network node is provided, the network node comprising memory circuitry, processor circuitry, and a wireless interface, wherein the network node is configured to perform the method disclosed herein.

It is an advantage of the present disclosure that the disclosed network node enables the wireless device during initial access to identify, based on the disclosed periodic sequence, a frequency resource where a following SBB will be transmitted. By allocating the SSBs according to the periodic sequence, the network node may indicate, to the one or more wireless devices, the frequency resources to be monitored for subsequent SSBs. By using different periodic sequences for different network nodes SSBs transmitted by the network nodes can be spread out over the occupied bandwidth, in order to avoid a collision of transmissions, without the need of having the network nodes synchronized. This may lead to a reduced likelihood of failed CCA procedures prior to transmitting the SSBs. Thereby a more robust SSB transmission is provided.

Further, a method is disclosed, performed by a wireless device, for obtaining a number of Synchronization Signal Blocks (SSBs). The method comprises receiving, from a network node, a first SSB according to a periodic sequence of frequency allocations for transmission of SSBs. The periodic sequence has a period where a first frequency resource is allocated to the first SSB and a second frequency resource is allocated to a second SSB, wherein the second frequency resource and the first frequency resource are different. The method comprises determining the second frequency resource for receiving the second SSB based on the periodic sequence.

Further, a wireless device is provided, the wireless device comprising memory circuitry, processor circuitry, and a wireless interface, wherein the wireless device is configured to perform the method disclosed herein.

It is an advantage of the present disclosure that the wireless device may be informed about the different frequency resources allocated for at least a first and a second SSB broadcasted by the network node. The wireless device is informed about which frequency resources the wireless device is to use to listen for SSBs according to the periodic sequence of frequency allocations. The wireless device may thereby monitor the frequency resources according to the periodic sequence of frequency allocations and may thus experience fewer failed SSB receptions. Thereby a quality of a link established based on the received SSBs may be improved.

### BRIEF DESCRIPTION OF THE DRAWINGS

The above and other features and advantages of the present disclosure will become readily apparent to those skilled in the art by the following detailed description of examples thereof with reference to the attached drawings, in which:

FIG. 1 is a diagram illustrating an example wireless communication system comprising an example network node and an example wireless device according to this disclosure,

FIG. 2 is a diagram illustrating an example periodic sequence of frequency allocations comprising an example ordered list of frequency resources according to one or more example methods herein,

FIG. 3 is a diagram illustrating an example periodic sequence of frequency allocations comprising an example ordered list of frequency resources according to one or more example methods herein,

FIG. 4 is a flow-chart illustrating an example method, performed by a network node, for transmission of a number of SSBs over a number of frequency resources to one or more wireless devices according to this disclosure,

FIG. 5 is a flow-chart illustrating an example method, performed by a wireless device, for obtaining a number of SSBs according to this disclosure,

FIG. 6 is a diagram illustrating an example periodic sequence of frequency allocations comprising an example randomized list of frequency resources according to one or more example methods herein,

FIG. 7 is a diagram illustrating an example periodic sequence of frequency allocations comprising an example randomized list of frequency resources according to one or more example methods herein,

FIG. 8 is a block diagram illustrating an example network node according to this disclosure, and

FIG. 9 is a block diagram illustrating an example wireless device according to this disclosure.

### DETAILED DESCRIPTION

Various examples and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the examples. They are not intended as an exhaustive description of the disclosure or as a limitation on the scope of the disclosure. In addition, an illustrated example needs not have all the aspects or advantages shown. An aspect or an advantage described in conjunction with a particular example is not necessarily limited to that example and can be practiced in any other examples even if not so illustrated, or if not so explicitly described.

In 3GPP NR, a network node, such as a gNB, periodically broadcasts SSBs for allowing a wireless device (WD) to find and synchronize to a beam of the network node. The SSBs also allows the WD to determine a best beam for communication between the wireless device and the network node. A beam may herein be seen as a spatial filter, indicative of a spatial direction. The network node may have a plurality of beams used for communication, such as radiated by the network node, such as Downlink (DL) beams, such as Transmit (Tx) beams, wherein each beam covers a different spatial direction. The network node may transmit multiple SSBs within a certain interval, such as within a certain period. Each SSB may be transmitted by the network node via a specific beam radiated in a certain direction. The wireless device may listen for SSBs and may measure the signal strength of each SSB it detects. Based on the measurement, such as based on a measurement result, the wireless device may identify the SSB ID with the strongest signal strength. The beam of the SSB with the strongest signal strength may be declared as the best beam for communicating with the wireless device. This best beam may be used for establishing a link, such as a radio link, between the WD and the network node.

In unlicensed frequency spectrums, a network node, such as a radio network node, such as a gNB, cannot take for granted that it can transmit SSB when and where it wishes as it may first perform a CCA, such as an LBT procedure. This may cause problems for WDs, such as a User Equipment (UE), during initial access procedures, since the WDs do not know in which frequency resource, such as a frequency band, to monitor or scan for SSBs. For example, if the WD does not receive an SSB in a monitored frequency resource, this may be due to the SSBs being transmitted in a different frequency range or the SSBs being temporarily absent due to a failed CCA. A failed CCA may e.g., be due to other WDs or network nodes transmitting on the channel. Moreover, it may in some example scenarios be assumed that the network node, such as the gNB, transmits SSBs at multiple frequencies. In such an example scenario, it may be assumed that if a WD finds a first SSB at a certain first frequency location, then a second frequency location of a subsequent second SSB may not be known to the WD. This may for example be due to the subsequent second SSB being blocked at the first frequency location, such as due to the LBT process indicating that the channel is occupied by other transmissions, and being transmitted in a second frequency resource different to the first frequency resource. It may be appreciated that the first SSB beam may be weaker than the second SSB beam. Since the WD may be unable to find the second SSB—which in this exemplary scenario is assumed to be associated with the better of the two beams—the subsequent link between the WD and the network node may be of inferior quality compared to an exemplary scenario where the second SSB associated to the second beam could be found by the WD.

According to the current disclosure, the second frequency location allocated to a second SSB may be deterministically known from the first frequency location of a first SSB according to a periodic sequence disclosed herein. In other words, the SSBs may be transmitted at respective frequency locations that may be given by a predefined pattern, such as a periodically repeated pattern.

A periodic sequence may be seen as a sequence of allocations of frequency resources that is repeated periodically.

In 3GPP NR, the network node, such as the gNB, transmits SSBs with a certain periodicity, such as for example with a period of 20 ms. Within each period, N SSBs may be transmitted, each SSB being associated with, such as transmitted via, its own beam. The collection of the N SSBs may herein be referred to as an SSB burst. Different SSB bursts may be assumed to have its SSBs transmitted using the same set of N beams, such as the same set of spatial filters, and having a single configured center frequency.

In one or more examples herein, B_{k,n} may denote an nth SSB of a kth SSB burst.

It may be appreciated that in licensed spectrums, all SSB B_{k,n} may be transmitted at a same frequency location which may herein be denoted F_{lic}. F_{lic} may be kept constant for a time-period so long that it, for all practical purposes, may be considered as infinite. Therefore, as soon as a WD attempting to perform initial access finds a single SSB, the WD knows where, such as at what time and frequency, to find all other SSBs.

In unlicensed spectrums however, it may be appreciated that a WD may manage to find a certain SSB, which may herein, without loss of generality, be referred to as B_{1,1}, at a first frequency resource, such as at a frequency location F₁. Since the LBT process may be performed on a per-beam-basis in unlicensed spectrums, the LBT process for a beam associated with a second SSB, such as an SSB B_{1,2}, may result in the second SSB being transmitted in a different frequency resource than F₁, such as in a second frequency resource F₂. The second frequency resource F₂ may be a frequency resource that has been determined as being clear from other traffic during the LBT process. Therefore, assuming the network node uses multiple frequencies for the SSB-bursts, the frequency location F₂ of B_{1,2} can be different from F₁. This may lead to the WD not receiving B_{1,2}. In some scenarios, the SSB B_{1,2} may not be transmitted at all. This may for example be the case if the LBT process fails at an intended frequency resource, such as a frequency location, F₂. In other words, the WD may not know in which frequency resource to monitor for the second SSB B_{1,2} although it could receive B_{1,1}. Therefore, the WD may fail to find any other SSBs besides B_{1,1}. This may lead to an established link being poorer than it potentially could be, or even worse, it may not be possible to establish a link at all.

The following figures are schematic and simplified for clarity, and they merely show details which aid understanding the disclosure, while other details have been left out. Throughout, the same reference numerals are used for identical or corresponding parts.

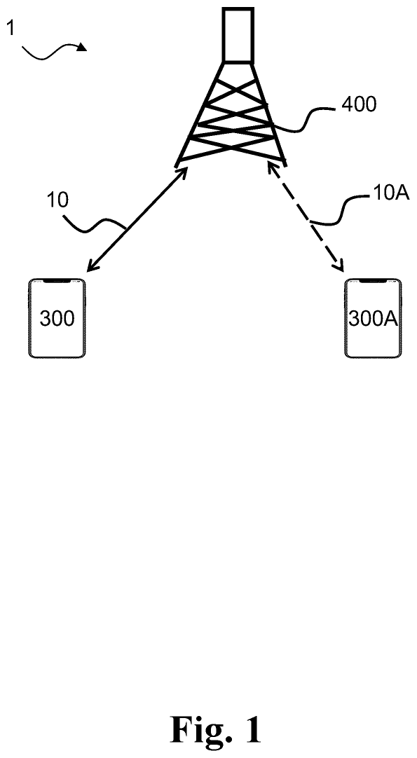

FIG. 1 is a diagram illustrating an example wireless communication system 1 comprising an example network node 400 and an example wireless device 300 according to this disclosure.

As discussed in detail herein, the present disclosure relates to a wireless communication system 1 comprising a cellular system, for example, a 3GPP wireless communication system. The wireless communication system 1 comprises a wireless device 300 and/or a network node 400.

A network node disclosed herein refers to a radio access network node operating in the radio access network, such as a base station, an evolved Node B, eNB, gNB in NR. In one or more examples, the RAN node is a functional unit which may be distributed in several physical units.

The wireless communication system 1 described herein may comprise one or more wireless devices 300, 300A, and/or one or more network nodes 400, such as one or more of: a base station, an eNB, a gNB and/or an access point.

A wireless device may refer to a mobile device and/or a user equipment, UE.

The wireless device 300, 300A may be configured to communicate with the network node 400 via a wireless link (or radio access link) 10, 10A.

The network node 400, such as the gNB, may periodically broadcast SSBs via a plurality of beams, such as transmit beams, for allowing the wireless device 300 to determine a best beam for setting up the wireless link 10 between the wireless device 300 and the network node 400.

It may be appreciated that each SSB B_{k,n} may be allocated to one out of I frequency resources of a set of frequency resources F={F₀, F₁, . . . , F_{I-1}}. According to the current disclosure, the SSBs B_{k,n} may be allocated to the set of frequency resources F according to a periodic sequence.

The periodic sequence can herein be seen as a mapping between the SSBs B_{k,n} and the frequency resources of the set F of frequency resources. The sequence is repeated periodically according to a period. In other words, the periodic sequence may be seen as exhibiting a periodicity, such as having periodic character, based on the period of the periodic sequence. A period of the periodic sequence may be seen as a period of a sequence of allocations of frequency resources.

The periodic sequence may be periodically repeated based on the period of the periodic sequence. In other words, for example, when the period expires, the periodic sequence is repeated. The periodic sequence may thus be seen as a sequence constructed by repeating, such as ad infinitum, a basic sequence of minimum length, wherein the basic sequence corresponds to the period of the periodic sequence.

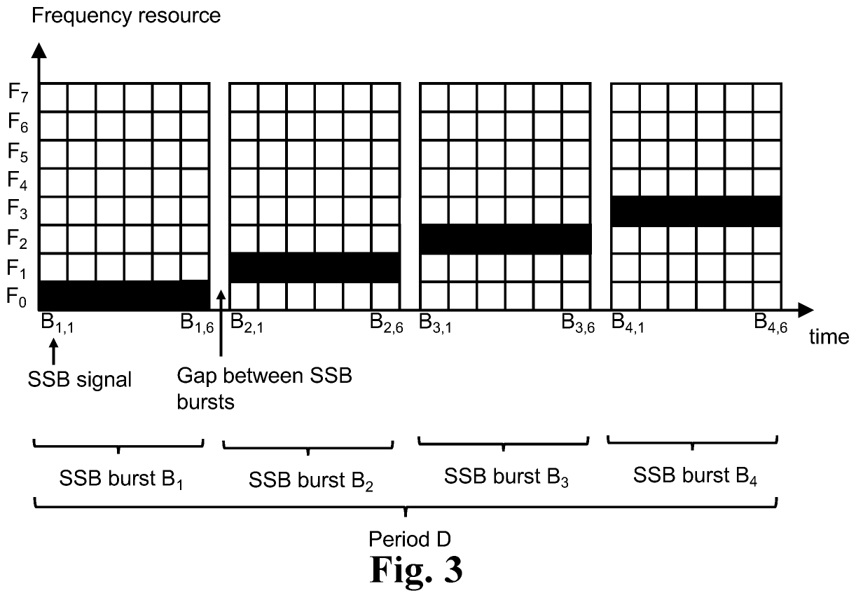

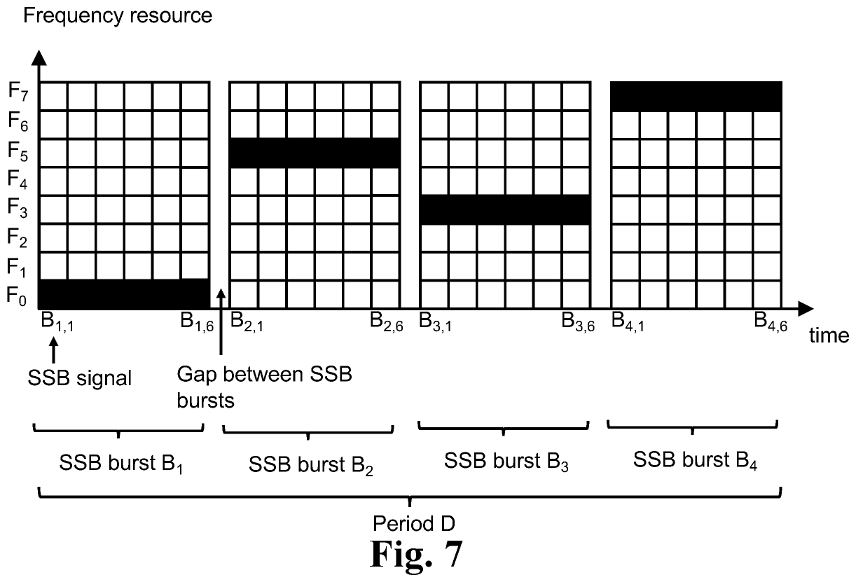

The period D may be selected such that each SSB, such as each beam, is present at each frequency with the same number of occurrences. In one or more example periodic sequences each SSB, such as each SSB associated with a beam of the network node, may be present in each SSB burst. In other words, SSB signals of all beams of the network node may be allocated in each SSB burst. In one or more example periodic sequences, each SSB, such as each SSB associated with a beam of the network node, may be allocated to each of the available frequencies over a number of SSB bursts with the same number of occasions, such as shown in FIG. 3 and FIG. 7. The period D of the periodic sequence may in one or more examples be determined based on the number of the available frequencies. In one or more example periodic sequences, the period D may be determined as a number of SSB burst. In one or more example periodic sequences, the period D may be determined as a number of SSBs.

In one or more example methods, the periodic sequence may comprise an ordered list of frequency resources from a set F={F₀, F₁, . . . , F_{I-1}} of frequency resources, where I is the number of frequency resources. In one or more example methods, the ordered list of frequency resources may be randomized. In some example methods, the randomized list of frequency resources may comprise multiple entries referring to the same frequency resource to achieve a pseudo-random behaviour of the ordered list. Each periodic sequence may have a sequence number, such as a sequence identifier, for identifying the periodic sequence. It may be appreciated that the WD may be aware of the periodic sequence, for example by being pre-configured with a plurality of periodic sequences or a single preconfigured periodic sequence. It may also be appreciated that the WD may determine the periodic sequence, for example by indirectly computing the periodic sequence, from other system parameters, such as from a cell identifier (ID) and a current frequency for a detected beam.

Control signalling transmitted to the WD may comprise an identifier of the periodic sequence for allowing the WD to identify the periodic sequence used for broadcasting the SSBs.

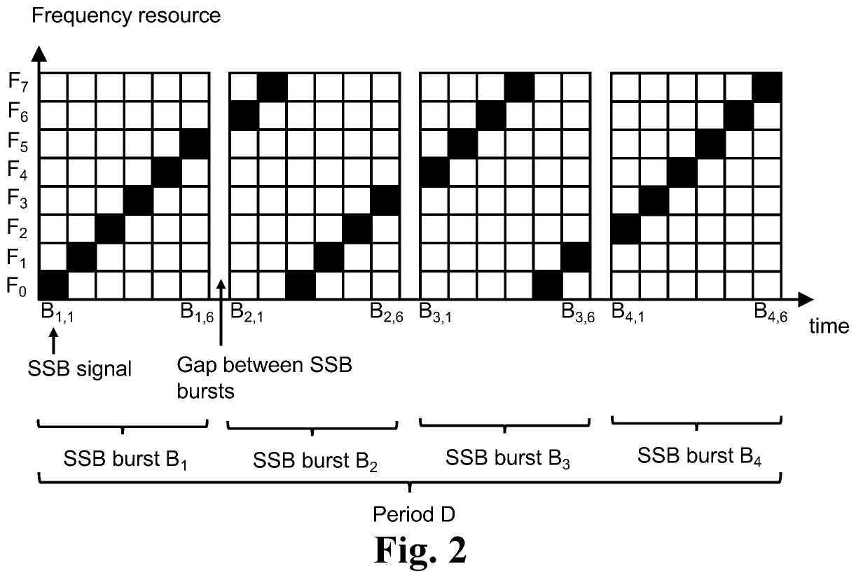

Examples of periodic sequences for allocating the frequency resources to the SSBs, such as mappings between the SSBs B_{k,n} and frequency resources Fᵢ, are illustrated in FIGS. 2, 3, 6 and 7. The network node may broadcast the SSBs in the frequency resources according to the periodic sequence. The wireless device may, upon receiving a first SSB (such as the SSB B_{k,n}) in a first frequency resource, determine, based on the periodic sequence, one or more second frequency resource(s) to monitor for one or more second SSB(s) (such as the SSB

FIG. 2 shows an example periodic sequence of frequency allocations according to one or more example methods disclosed herein. The periodic sequence of frequency allocations may herein be seen as a mapping of SSB transmissions, such as SSBs, to frequency resources. It can be seen from FIG. 2 that SSBs are transmitted in a plurality of SSB bursts Bₖ, where k indexes the number of bursts. The SSB bursts are separated by a time gap. Each SSB burst comprises a number of SSBs associated to a respective beam, such as to a spatial filter. The number of SSBs in each SSB burst may thus correspond to the beams available for transmission at the network node.

In the example periodic sequence of frequency allocations shown in FIG. 2, the SSBs are frequency staggered, such as frequency staggered within a same SSB burst. The SSBs being frequency staggered herein means that the frequency allocation changes for each SSB within the SSB burst. In other words, SSBs, such as a first and a second SSB, may not be allocated in a same frequency resource within an SSB burst, instead each SSB may be transmitted in a respective frequency resource of the periodic sequence. The SSBs being frequency staggered may herein be referred to as Mapping 1.

In the example periodic sequence of FIG. 2, the frequency resources of the set of frequency resources F={F₀, F₁, . . . , F_{I-1}} are arranged in an ordered list where the frequency of Fᵢ<F_{i+1, mod I}. In other words, if a first SSB B_{k,n}, where n is the nth SSB in the kth burst, is transmitted at a first frequency resource Fⱼ, then a second SSB B_{k,n+1} (or B_{k+1,1} if n=N, such as when the first SSB B_{k,n} is the last SSB of an SSB burst) may be transmitted at the frequency resource F_{j+1 mod I}, where I is the number of available frequency resources. For example, the period D of the periodic sequence may be based on the number of available frequency resources, such as a number of the frequency resources of the set of frequency resources. For example, the periodic sequence may be a modulo function based on the period, such as based on the I available frequency resources, or a selected set of center frequencies, such as mod I. For example, with a period sequence mod I when B_{k,n} is transmitted at the last frequency resource F_{I-1}, then the next SSB is transmitted at F₀.

The periodic sequence may be repeated according to the period D of the periodic sequence. The period D of the example periodic sequence according to Mapping 1, such as the example periodic sequence of FIG. 2, may be determined by D=P=q*I/N, where P is a number of SSB bursts, I is the number of frequency resources available in the frequency spectrum, N is the number of SSBs transmitted within one SSB burst, and q is the smallest integer such that q*UN is an integer. In the example shown in FIG. 2, N=6 SSBs (corresponding to 6 beams) are transmitted within each SSB burst, and I=8 frequency resources are available for allocation of the SSBs in the periodic sequence. For example, the number of frequency resources in the periodic sequence of frequency allocations may be higher than the number of SSBs transmitted with one SSB burst. Therefore, SSBs may not be transmitted in all frequency resources within one SSB burst. A pattern, such as a pattern of frequency allocations, of the periodic sequence may therefore be continued in the following SSB burst. In other words, the period of the periodic sequence may be configured such that an equal number of SSBs is allocated in each frequency resource. The smallest integer allowing that the period D D=P=q*UN is an integer number of SSB bursts in the example periodic sequence of FIG. 2 is q=3. Thus, the period D of the example periodic sequence shown in FIG. 2 may in one or more examples be determined as D=P=q*I/N=3*8/6=4 SSB bursts. It may be appreciated that in one or more examples, the periodicity D (such as the period D) may be expressed as a number of SSBs, such as D=q*I.

FIG. 3 shows an example periodic sequence of frequency allocations according to one or more example methods disclosed herein. In the example periodic sequence of frequency allocations shown in FIG. 3, the SSB bursts are frequency staggered. The SSB bursts being frequency staggered herein means that the SSBs transmitted in different SSB bursts are allocated to different frequency resources, such that SSBs of one of the SSB bursts are not allocated to the same frequency resource as the SSBs of any subsequent SSB bursts of the periodic sequence. As can be seen in the example periodic sequence shown in FIG. 3, all SSB signals transmitted in a same SSB burst, such as e.g., the SSBs B_{1,1} to B_{1,6} transmitted in the first SSB burst, are allocated to the same frequency resource, namely to frequency resource F₀. The frequency resource allocated to the SSBs of a subsequent SSB burst then changes to a frequency resource different than the frequency resource allocated to the SSBs in the previous SSB burst according to the periodic sequence. The SSB bursts being frequency staggered may herein be referred to as Mapping 2.

In the example periodic sequence of FIG. 3, the frequency resources of the set of frequency resources F={F₀, F₁, . . . , F_{I-1}} are arranged in an ordered list where the frequency of Fᵢ<F_{i+1, mod I}. In other words, if a first SSB signal B_{k,n}, where n is the nth SSB signal in the kth burst, is transmitted at a first frequency resource Fⱼ, then a second SSB signal B_{k+1,n} may be transmitted at the frequency resource F_{j+1 mod I}, where I is the number of available frequency resources. In the example periodic sequence shown in FIG. 3, the period D of the periodic sequence may be based on the number of available frequency resources I, such as equal to or less than I. The period D may for example be determined based on the number of frequency resources out of the available frequency resources that are comprised in the periodic sequence and the duration allocated to each frequency resource. In the example periodic sequence shown in FIG. 3, four frequency resources are available, such that I=4. Hence, the periodicity D (such as the period D) of the example periodic sequency in FIG. 3 may be 4 SSB bursts if the pattern is repeated. It may however be appreciated that the periodic sequence may comprise allocations to further frequency resources.

It may be appreciated that in unlicensed frequency bands, an LBT procedure, precedes any SSB transmission. Hence, the periodic sequence of frequency allocations indicates the intended transmissions of SSBs. However, the LBT procedure may prevent an actual transmission of the SSBs, for example when one of the frequency resources allocated to the SSBs is occupied by other transmissions.

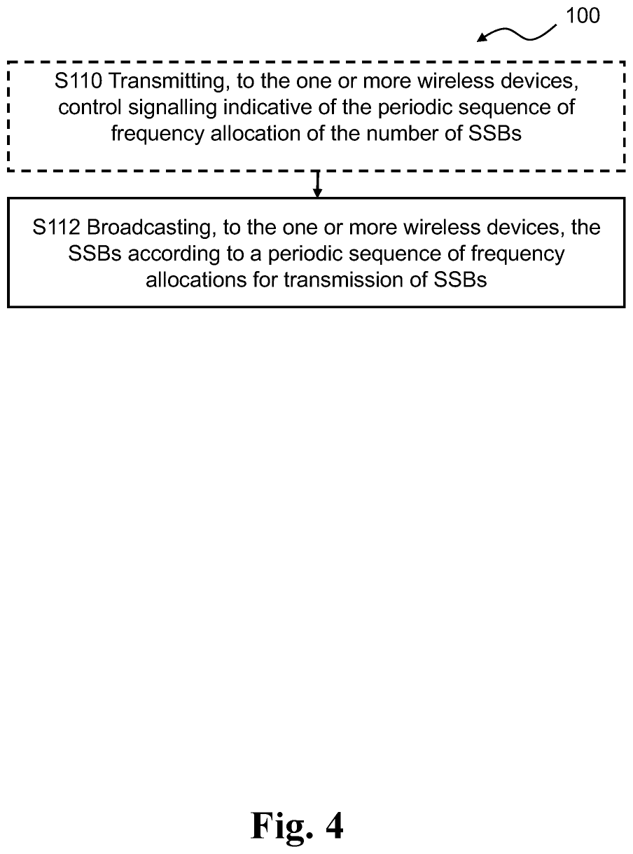

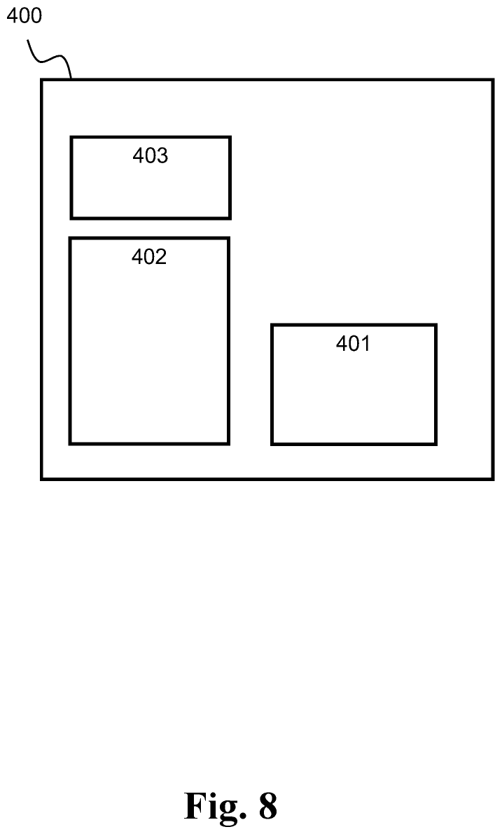

FIG. 4 shows a flow diagram of an example method 100, performed by a network node according to the disclosure, for transmission of a number of SSBs over a number of frequency resources to one or more wireless devices. Each SSB is associated with a corresponding beam. The network node is the network node disclosed herein, such as network node 400 of FIG. 1 and FIG. 8.

The method 100 comprises broadcasting S112 the SSBs according to a periodic sequence of frequency allocations for transmission of SSBs. The periodic sequence has a period where a first frequency resource is allocated to a first SSB and a second frequency resource is allocated to a second SSB. The second frequency resource and the first frequency resource are different, such as different from each other. The periodic sequence is repeated periodically according to the period. In other words, the period may be seen as indicating when the periodic sequence is to be repeated. In one or more example methods, the frequency resources, such as the first and/or the second frequency resources, may be allocated in an unlicensed frequency spectrum. In one or more example methods, the frequency resources, such as the first and/or the second frequency resources, may be allocated in a licensed frequency spectrum.

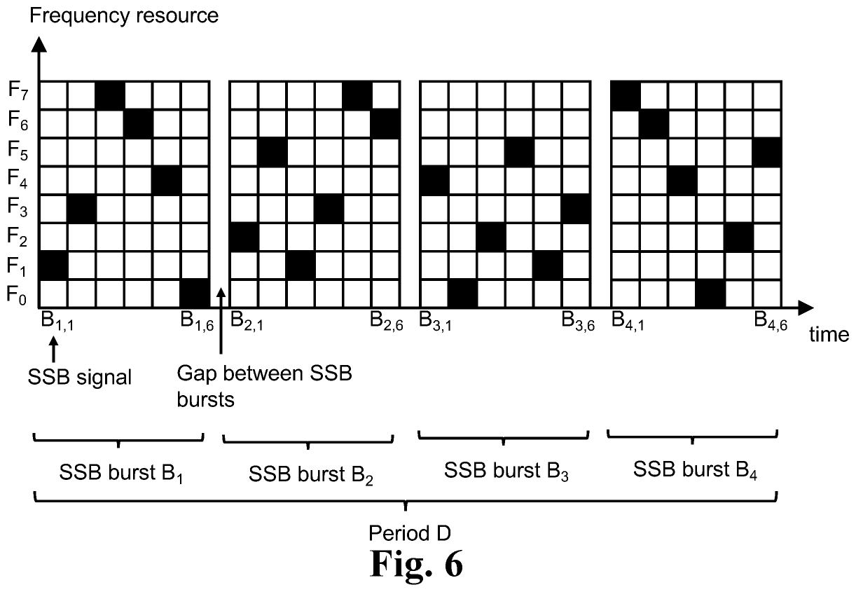

In one or more example methods, the first SSB and the second SSB may be transmitted within the same SSB burst. The periodic sequence may for example indicate a staggering of the first SSB and the second SSB in frequency, such as a staggering of the first SSB and the second SSB in frequency within the same SSB burst. In other words, the first SSB and the second SSB may be allocated to different frequency resources within the same SSB burst. The first SSB and the second SSB may be subsequent SSBs, such as SSBs transmitted using subsequent beams within the SSB burst. Subsequent SSBs herein means that the SSBs and/or the beams are transmitted in different, such as subsequent, time resources. The subsequent SSBs may for example be consecutive SSBs, such as SSBs transmitted in consecutive beams, or SSBs transmitted after each other and potentially having other SSBs transmitted between them. In other words, according to one or more example methods, any subsequent SSBs transmitted in the same SSB burst may be transmitted in separate frequency resources. This corresponds to the example periodic sequences shown in FIG. 2 and in FIG. 6.

In one or more example methods, the first SSB may belong to a first SSB burst and the second SSB may belong to a second SSB burst. The first SSB burst and the second SSB burst may be different. For example, the first SSB may be transmitted in the first frequency resource in the first SSB burst and the second SSB may be transmitted in the second frequency resource in the second SSB burst. In one or more example methods, the first SSB burst and the second SSB burst may be subsequent SSB bursts.

In one or more example methods, the periodic sequence may indicate that the frequency allocations of the first SSB burst and the second SSB burst are staggered. When the frequency allocations of the first SSB burst and the second SSB burst are staggered, the SSBs within the same SSB burst may be allocated to the same frequency and a shift in frequency allocation for the SSBs occurs between subsequent SSB bursts. This corresponds to the example periodic sequences illustrated in FIG. 3 and FIG. 7. An advantage of the SSB burst being frequency staggered may be that the method is easier to implement, since the network node and/or the WD may not be required to rapidly change frequency resource for transmitting and/or receiving SSBs.

In one or more example methods, the periodic sequence may comprise an ordered list of frequency resources from a set F={F₀, F₁, . . . , F_{I-1}} of frequency resources, where I is the number of frequency resources. The set of frequency resources F may comprise the frequency resources in the frequency spectrum that are available for allocation of SSBs. In one or more example methods, the frequency resources in the ordered list may be arranged in an ascending or descending order. In other words, when the frequency resources are arranged in an ascending order a subsequent frequency resource Fⱼ₊₁ may be located in a higher frequency range than a preceding frequency resource F^{j}, such that Fⱼ<F_{j+1, mod I}, where j=0, . . . , I−2. When the frequency resources are arranged in an ascending order a subsequent frequency resource Fⱼ₊₁ may be located in a lower frequency range than preceding frequency resource Fⱼ, such that Fⱼ>F_{j+1, mod I}, where j=0, . . . , I−2. For example, the frequency resources may be arranged such that the periodic sequence starts with the lowest frequency resource of the set of frequency resources, such as with the frequency resource F₀, and ends with the highest frequency resource of the set of frequency resources, such as with the frequency resource F_{I-1}, or vice versa. An advantage with the periodic sequence comprising an ordered list of frequency resources in an ascending or descending order may be that the WD does not have to be notified about the specific sequence of frequency resources and may monitor for a next logical frequency resource, such as in a consecutive frequency resource from the frequency resource in which the WD has received a first SSB.

In one or more example methods, the ordered list of frequency resources may be pseudo-randomized. Pseudo-randomized herein means that the order of the frequency resources in the periodic sequence may be randomized, such as not being arranged in an ascending or descending order, but that the same randomized sequence of frequency resources is repeated according to the period of the periodic sequence. In other words, the frequency resources of the set of frequency resources may be arranged in any order in the periodic sequence. Thereby, the probability of a plurality of network nodes repeatedly transmitting SSBs in the same frequency resources may be reduced which increases the probability of the LBT procedure resulting in a clear channel and allowing the SSB to be transmitted in the intended frequency resource according to the periodic sequence. In one or more example periodic sequences, the pseudo-randomized list may comprise multiple entries referring to the same frequency resource to achieve a pseudo-random behaviour of the periodic sequence.

In one or more example methods, the method comprises transmitting S110, to the one or more wireless devices, control signaling indicative of the periodic sequence of frequency allocation of the number of SSBs. The control signaling indicative of the periodic sequence may be comprised in one or more of the number of SSBs or in associated broadcast control channels, such as in a Physical Downlink Control Channel (PDCCH) and/or in a Physical Downlink Shared Channel (PDSCH). In one or more examples, the control signaling indicative of the periodic sequence may be comprised in each SSB. Upon the WD receiving an SSB at a first frequency resource it may determine the second frequency resource for receiving the second SSB based on the control signaling comprised in the SSB. In one or more example methods, the control signaling may be comprised in a first SSB, such as for example the first SSB of each SSB burst.

In one or more example methods, the periodic sequence is preconfigured. The periodic sequence may be preconfigured in the wireless device and/or the network node. The periodic sequence may e.g., be preconfigured upon initial setup. In one or more example methods a plurality of periodic sequences may be preconfigured. In one or more example methods, the control signaling may comprise a flag indicative of the periodic sequence. The flag may for example indicate that a previously signaled periodic sequence or a preconfigured periodic sequence shall be activated. In one or more example methods, the control signaling may comprise a plurality of flags. Each of the plurality of flags may correspond to a respective periodic sequence of the plurality of preconfigured periodic sequences. By using a flag in the control signaling indicative of the periodic sequence to indicate the periodic sequence to be used, the WD may be informed about the periodic sequence without having to transmit the actual periodic sequence. Thereby the amount of control signaling having to be transmitted can be reduced.

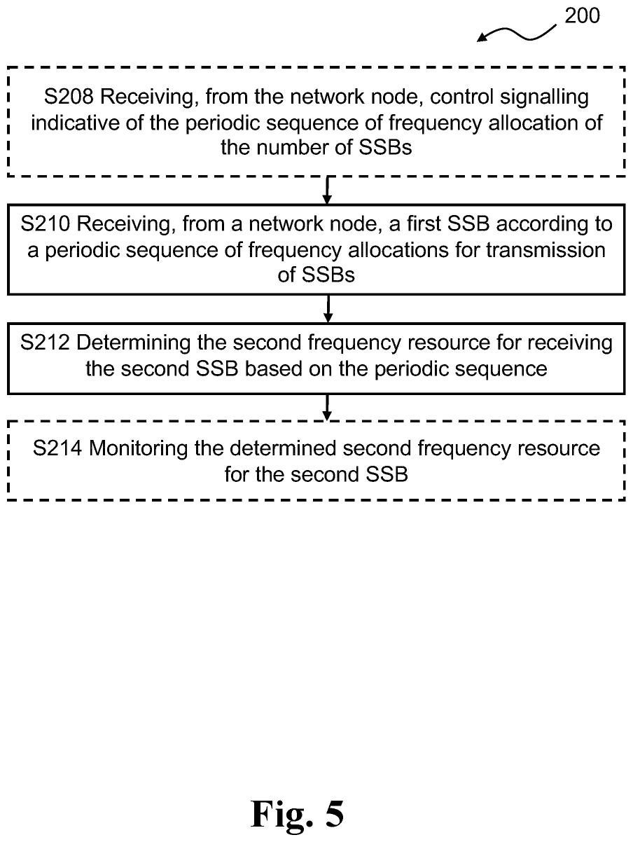

In one or more example methods, the period, such as the period illustrated in FIGS. 2 and 5, of the periodic sequence is based on one or more of: the number of frequency resources and the number of SSBs in one SSB burst. In one or more example methods, the periodic sequence may be repeated over a number of SSB bursts according to the period. In one or more example methods, in the periodic sequence the available frequency resources may be repeatedly allocated to the SSBs over P SSB bursts according to a pattern, for example until the same number of SSBs have been allocated in each of the available frequency resources of the periodic sequence. This may correspond to the period D of the periodic sequence. In the example methods where the periodic sequence indicates that the SSBs within one SSB burst are frequency staggered, such as the example methods shown in FIG. 2 and in FIG. 6, the period D may be determined based on the number of frequency resources and the number of SSB bursts according to P=q*UN, where I is the number of frequency resources available in the frequency spectrum, N is the number of SSBs transmitted within one burst, and q is the smallest integer such that q*UN is an integer. In the example methods, where the periodic sequence indicates that the SSB bursts are frequency staggered, such as the example methods shown in FIG. 3 and in FIG. 7, the period may be determined based on the number of available frequency resources, such as the number of available frequency resources in the periodic sequence of frequency allocation.

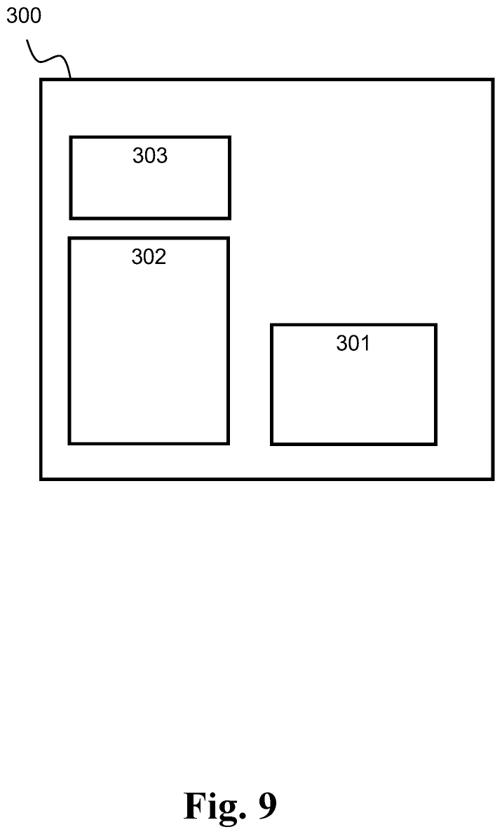

FIG. 5 shows a flow diagram of an example method 200, performed by a wireless device, for obtaining a number of SSBs. The method 200 comprises receiving S210, from a network node, a first SSB according to a periodic sequence of frequency allocations for transmission of SSBs. The periodic sequence has a period where a first frequency resource is allocated to the first SSB and a second frequency resource is allocated to a second SSB. The second frequency resource and the first frequency resource are different. The method 200 comprises determining S212 the second frequency resource for receiving the second SSB based on the periodic sequence. The WD is the WD disclosed herein, such as the WD 300 of FIG. 1 and FIG. 9. The frequency resources, such as the first and the second frequency resources, may be allocated in an unlicensed frequency spectrum.

In one or more example methods, the first SSB and second SSB belong to the same SSB burst. The periodic sequence may for example indicate a staggering of the first SSB and the second SSB in frequency, such as a staggering of the first SSB and the second SSB in frequency within the same SSB burst. In other words, the periodic sequence may indicate to the WD that the first SSB and the second SSB are allocated to different frequency resources within the same SSB burst. The first SSB and the second SSB may be subsequent SSBs, such as SSBs transmitted using subsequent, such as consecutive beams within the SSB burst. Based on the indication that the first SSB and the second SSB belong to the same SSB burst, the WD may determine that the second SSB is allocated to a second frequency resource in the same SSB burst as the first SSB received from the network node. It may be appreciated that further SSBs, such as a third SSB, a fourth SSB, a fifth SSB etc. may also be comprised in the same SSB burst, and may have respective frequency resources, from the set F of frequency resources allocated to them.

In one or more example methods, the first SSB belongs to a first SSB burst and the second SSB belongs to a second SSB burst, wherein the first SSB burst and the second SSB burst are different. The first SSB burst and the second SSB burst may be subsequent SSB bursts. Subsequent SSB bursts herein means that the SSB bursts beams are transmitted in different, such as subsequent, time resources. The subsequent SSB bursts may for example be consecutive SSB bursts, such as consecutive SSB bursts or SSB bursts being transmitted after each other and potentially having other SSB bursts transmitted between them. In one or more example methods, the periodic sequence may indicate that the frequency allocations of the first SSB burst and the second SSB burst are staggered. The periodic sequence may thus indicate to the WD that the second SSB is allocated to the second frequency resource in a second SSB burst, such as an SSB burst different to the SSB burst in which the first SSB was received.

In one or more example methods, the periodic sequence comprises an ordered list of frequency resources from a set F={F₀, F₁, . . . , F_{I-1}} of frequency resources, where I is the number of frequency resources. In one or more examples, the frequency resources in the ordered list may be arranged in an ascending or descending order. In other words, when the frequency resources are arranged in an ascending order a subsequent frequency resource Fⱼ₊₁ may be located in a higher frequency range than a preceding frequency resource Fⱼ, such that Fⱼ<F_{j+1, mod I}, where j=0, . . . , I−2. When the frequency resources are arranged in an ascending order a subsequent frequency resource Fⱼ₊₁ may be located in a lower frequency range than preceding frequency resource Fⱼ, such that Fⱼ>F_{j+1, mod I}, where j=0, . . . , I−2. When the periodic sequence comprises the ordered list of frequency resources in an ascending or descending order the WD does not have to be aware of a specific sequence and may monitor for the second SSB in a next logical frequency resource, such as in a consecutive frequency resource from the frequency resource in which the WD received the first SSB.

In one or more example methods, the ordered list of frequency resources may be pseudo-randomized. In other words, the frequency resources of the set of frequency resources may be arranged in any order in the periodic sequence.

In one or more example methods, the method comprises monitoring S214 the determined second frequency resource for the second SSB. Once the WD has determined the second frequency resource for receiving the second SSB, the WD monitors the determined frequency resource for the second SSB.

In one or more example methods, the method comprises receiving S208, from the network node, control signaling indicative of the periodic sequence of frequency allocations of the number of SSBs. In one or more example methods, the control signaling indicative of the periodic sequence is comprised in one or more of the number of SSBs or in associated broadcast control channels, such as in a Physical Downlink Control Channel (PDCCH) and/or in a Physical Downlink Shared Channel (PDSCH). In one or more examples, the control signaling indicative of the periodic sequence may be comprised in each SSB. Upon the WD receiving an SSB at a first frequency it may determine the second frequency resource for receiving the second SSB based on the control signaling comprised in the SSB. In one or more example methods, the control signaling may be comprised in a first SSB, such as for example the first SSB of each SSB burst.

In one or more example methods, the periodic sequence may be preconfigured. The periodic sequence may be preconfigured in the wireless device. The periodic sequence may e.g., be preconfigured upon initial setup of the WD. In one or more example methods a plurality of periodic sequences may be preconfigured in the WD, wherein the plurality of periodic sequences are different from each other. Each periodic sequence may have a sequence number, such as a sequence identifier, for identifying the periodic sequence. In one or more examples, the control signaling received from the network node may comprise an identifier for identifying the sequence number of the periodic sequence to be used. Based on the identifier the WD may determine the periodic sequence out of the plurality of periodic sequences that is to be used for determining the second frequency location of the second SSB.

In one or more example methods, the control signaling may comprise a flag indicative of the periodic sequence. The flag may for example indicate that a previously signaled periodic sequence or a preconfigured periodic sequence is used by the network node to transmit SSBs. For example, the flag may indicate to the WD that a previously signaled periodic sequence is used for transmitting SSBs. Based on the flag the WD may know that the previously signaled periodic sequence is to be used to determine the second frequency resource for monitoring for the second SSB. In one or more example methods, such as when a plurality of periodic sequences has been preconfigured, the control signaling may comprise a plurality of flags. Each of the plurality of flags may correspond to a respective periodic sequence of the plurality of preconfigured periodic sequences. By using a flag in the control signaling indicative of the periodic sequence to indicate the periodic sequence to be used, the WD may be informed about the periodic sequence without having to transmit the actual periodic sequence. Thereby the amount of control signaling having to be transmitted can be reduced.

FIG. 6 shows an example periodic sequence according to one or more example methods herein, wherein the periodic sequence is randomized, such as pseudo-randomized. The example periodic sequence of FIG. 6 is similar to the example periodic sequence of FIG. 2, however instead of the frequency resources of the set of frequency resources F={F₀, F₁, . . . , F_{I-1}} being arranged in an ordered list (such as in an increasing order), the frequency resources of the set of frequency resources F={F₀, F₁, . . . , F_{I-1}} are arranged in a randomized list. As can be seen in FIG. 6, the randomized list of frequency resources in the example periodic sequence is F_{rand}=(F₁, F₃, F₇, F₆, F₄, F₀, F₂, F₅). The example periodic sequence follows Mapping 1, such that the SSBs are frequency staggered within an SSB burst. In other words, the frequency allocation changes for each SSB in the same SSB burst according to the randomized list of frequency resources. Once all of the frequency resources in the randomized list have been allocated to SSBs, the randomized list is repeated in accordance with the period D. The period D for repeating the periodic sequence of transmission of the example periodic sequence according to Mapping 1, such as the example periodic system of FIG. 6, may in one or more examples be determined as D=P=q*I/N, where I is the number of frequency resources available in the frequency spectrum, N is the number of SSBs transmitted within one burst, and q is the smallest integer which suffices that q*UN is an integer.

FIG. 7 shows an example periodic sequence according to one or more example methods herein, wherein the periodic sequence is randomized, such as pseudo-randomized. The example periodic sequence of FIG. 7 is similar to the example periodic sequence of FIG. 3, however instead of the frequency resources of the set of frequency resources F={F₀, F₁, . . . , F_{I-1}} being arranged in an ordered list, the frequency resources of the set of frequency resources F={F₀, F₁, . . . , F_{I-1}} are arranged in a randomized list. The example periodic sequence follows Mapping 2, such that the SSB bursts are frequency staggered. The period D of the example periodic sequence according to Mapping 2 may be determined based on I. The period D may for example be determined based on the number of frequency resources out of the available frequency resources that are comprised in the periodic sequence and the duration allocated to each frequency resource. In the example periodic sequence shown in FIG. 7, I=4 and the period D may therefore in one or more examples be determined as D=I=4 SSB bursts. It may be appreciated that the period D may also be expressed as a number of SSBs, such as D=I*N, which in this example periodic sequence, where 6 SSBs are transmitted in each SSB burst, would be 4*6=24 SSBs.

FIG. 8 shows a block diagram of an example network node 400 according to the disclosure. The network node 400 comprises circuitry that is configured to cause the apparatus to perform the method disclosed herein, such as memory circuitry 401, processor circuitry 402, and a wireless interface 403. The network node 400 may be configured to perform any of the methods disclosed in FIG. 4. In other words, the network node 400 may be configured for transmission of a number of SSBs over a number of frequency resources to one or more wireless devices.

The network node 400 is configured to communicate (such as via the wireless interface 403) with a WD, such as the WD 300 and/or 300A (shown in FIG. 9 and FIG. 1) disclosed herein, using a wireless communication system.

The wireless interface 403 is configured for wireless communications via a wireless communication system, such as a 3GPP system, such as a 3GPP system supporting one or more of: New Radio, NR, Narrow-band IoT, NB-IoT, and Long Term Evolution-enhanced Machine Type Communication, LTE-M.

The network node 400 is configured to broadcast (such as via the wireless interface 403) the SSBs according to a periodic sequence of frequency allocations for transmission of SSBs. The periodic sequence has a period where a first frequency resource is allocated to a first SSB and a second frequency resource is allocated to a second SSB. The second frequency resource and the first frequency resource are different.

Processor circuitry 402 is optionally configured to perform any of the operations disclosed in FIG. 4 (such as any one or more of S110). The operations of the network node 400 may be embodied in the form of executable logic routines (for example, lines of code, software programs, etc.) that are stored on a non-transitory computer readable medium (for example, memory circuitry 401) and are executed by processor circuitry 402).

Furthermore, the operations of the network node 400 may be considered a method that the network node 400 is configured to carry out. Also, while the described functions and operations may be implemented in software, such functionality may also be carried out via dedicated hardware or firmware, or some combination of hardware, firmware and/or software.

Memory circuitry 401 may be one or more of a buffer, a flash memory, a hard drive, a removable media, a volatile memory, a non-volatile memory, a random access memory (RAM), or other suitable device. In a typical arrangement, memory circuitry 401 may include a non-volatile memory for long term data storage and a volatile memory that functions as system memory for processor circuitry 402. Memory circuitry 401 may exchange data with processor circuitry 402 over a data bus. Control lines and an address bus between memory circuitry 401 and processor circuitry 402 also may be present (not shown in FIG. 8). Memory circuitry 401 is considered a non-transitory computer readable medium.

Memory circuitry 401 may be configured to store information, such as information indicative of the periodic sequence, in a part of the memory.

FIG. 9 shows a block diagram of an example wireless device 300 according to the disclosure. The wireless device 300 comprises circuitry that is configured to cause the apparatus to perform the method disclosed herein, such as memory circuitry 301, processor circuitry 302, and a wireless interface 303. The wireless device 300 may be configured to perform any of the methods disclosed in FIG. 5. In other words, the wireless device 300 may be configured for obtaining a number of SSBs.

The wireless device 300 is configured to communicate (such as via wireless interface 303) with a network node, such as the network node 400 (shown in FIG. 1 and FIG. 8) and wireless device, such as wireless device 300A (shown in FIG. 1) disclosed herein, using a wireless communication system.

The wireless device 300 is configured to receive (such as via the wireless interface 303), from a network node, a first SSB according to a periodic sequence of frequency allocations for transmission of SSBs, wherein the periodic sequence has a period where a first frequency resource is allocated to the first SSB and a second frequency resource is allocated to a second SSB, wherein the second frequency resource and the first frequency resource are different.

The wireless device 300 is configured to determine (such as using the processor circuitry 302) the second frequency resource for receiving the second SSB based on the periodic sequence.

The wireless interface 303 is configured for wireless communications via a wireless communication system, such as a 3GPP system, such as a 3GPP system supporting one or more of: New Radio, NR, Narrow-band IoT, NB-IoT, and Long Term Evolution-enhanced Machine Type Communication, LTE-M.

The wireless device 300 is optionally configured to perform any of the operations disclosed in FIG. 5 (such as any one or more of S208, S214). The operations of the wireless device 300 may be embodied in the form of executable logic routines (for example, lines of code, software programs, etc.) that are stored on a non-transitory computer readable medium (for example, memory circuitry 301) and are executed by processor circuitry 302).

Furthermore, the operations of the wireless device 300 may be considered a method that the wireless device 300 is configured to carry out. Also, while the described functions and operations may be implemented in software, such functionality may also be carried out via dedicated hardware or firmware, or some combination of hardware, firmware and/or software.

Memory circuitry 301 may be one or more of a buffer, a flash memory, a hard drive, a removable media, a volatile memory, a non-volatile memory, a random access memory (RAM), or other suitable device. In a typical arrangement, memory circuitry 301 may include a non-volatile memory for long term data storage and a volatile memory that functions as system memory for processor circuitry 302. Memory circuitry 301 may exchange data with processor circuitry 302 over a data bus. Control lines and an address bus between memory circuitry 301 and processor circuitry 302 also may be present (not shown in FIG. 9). Memory circuitry 301 is considered a non-transitory computer readable medium.

Memory circuitry 301 may be configured to store information (such as information indicative of the periodic sequence) in a part of the memory.

Examples of methods and products (network node and wireless device) according to the disclosure are set out in the following items:

Item 1. A method, performed by a network node, for transmission of a number of Synchronization Signal Blocks, SSBs, over a number of frequency resources to one or more wireless devices, wherein each SSB is associated with a corresponding beam, the method comprising:
broadcasting (S112) the SSBs according to a periodic sequence of frequency allocations for transmission of SSBs, wherein the periodic sequence has a period where a first frequency resource is allocated to a first SSB and a second frequency resource is allocated to a second SSB, wherein the second frequency resource and the first frequency resource are different.

Item 2. The method according to Item 1, wherein the first SSB and second SSB are transmitted within the same SSB burst.

Item 3. The method according to Item 2, wherein the first SSB and the second SSB are subsequent SSBs.

Item 4. The method according to any one of Items 1 to 3, wherein the periodic sequence indicates a staggering of the first SSB and the second SSB in frequency.

Item 5. The method according to Item 1, wherein the first SSB belongs to a first SSB burst and the second SSB belongs to a second SSB burst, wherein the first SSB burst and the second SSB burst are different.

Item 6. The method according to Item 5, wherein the first SSB burst and the second SSB burst are subsequent SSB bursts.

Item 7. The method according any one of Items 5 to 6, wherein the periodic sequence indicates that the frequency allocations of the first SSB burst and the second SSB burst are staggered.

Item 8. The method according to any one of the previous Items, wherein the periodic sequence comprises an ordered list of frequency resources from a set F={F₀, F₁, . . . , F_{I-1}} of frequency resources, where I is the number of frequency resources.

Item 9. The method according to Item 8, wherein the frequency resources in the ordered list are arranged in an ascending or descending order.

Item 10. The method according to Item 8, wherein the ordered list of frequency resources is pseudo-randomized.

Item 11. The method according to any one of the Items 1 to 10, the method comprising:
transmitting (S110), to the one or more wireless devices, control signaling indicative of the periodic sequence of frequency allocation of the number of SSBs.

Item 12. The method according to Item 11, wherein the control signaling indicative of the periodic sequence is comprised in one or more of the number of SSBs or in associated broadcast control channels.

Item 13. The method according to Item 11 or 12, wherein the control signaling comprises a flag indicative of the periodic sequence.

Item 14. The method according to any one of the previous Items, wherein the period of the periodic sequence is based on one or more of: the number of frequency resources and the number of SSBs in one SSB burst.

Item 15. The method according to any one of the previous Items, wherein the periodic sequence is preconfigured.

Item 16. The method according to any one of the previous Items, wherein the frequency resources are allocated in an unlicensed frequency spectrum.

Item 17. A method, performed by a wireless device, for obtaining a number of Synchronization Signal Blocks, SSBs, the method comprising:
receiving (S210), from a network node, a first SSB according to a periodic sequence of frequency allocations for transmission of SSBs, wherein the periodic sequence has a period where a first frequency resource is allocated to the first SSB and a second frequency resource is allocated to a second SSB, wherein the second frequency resource and the first frequency resource are different; and
determining (S212) the second frequency resource for receiving the second SSB based on the periodic sequence.

Item 18. The method according to Item 17, wherein the method comprises:
monitoring (S214) the determined second frequency resource for the second SSB.

Item 19. The method according to Item 17 or 18, wherein the first SSB and second SSB belong to the same SSB burst.

Item 20. The method according to Item 19, wherein the first SSB and the second SSB are subsequent SSBs.

Item 21. The method according to any one of Item 17 to 20, wherein the periodic sequence indicates a staggering of the first SSB and the second SSB in frequency.

Item 22. The method according to Item 17 or 18, wherein the first SSB belongs to a first SSB burst and the second SSB belongs to a second SSB burst, wherein the first SSB burst and the second SSB burst are different.

Item 23. The method according to Item 22, wherein the first SSB burst and the second SSB burst are subsequent SSB bursts.

Item 24. The method according any one of Items 22 to 23, wherein the periodic sequence indicates that the frequency allocations of the first SSB burst and the second SSB burst are staggered.

Item 25. The method according to any one of the Items 17 to 24, wherein the periodic sequence comprises an ordered list of frequency resources from a set F={F₀, F₁, . . . , F_{I-1}} of frequency resources, where I is the number of frequency resources.

Item 26. The method according to Item 25, wherein the frequency resources in the ordered list are arranged in an ascending or descending order.

Item 27. The method according to Item 25, wherein the ordered list of frequency resources is pseudo-randomized.

Item 28. The method according to any one of the Items 17 to 27, the method comprising:
receiving (S208), from the network node, control signaling indicative of the periodic sequence of frequency allocation of the number of SSBs.

Item 29. The method according to Item 28, wherein the control signaling indicative of the periodic sequence is comprised in one or more of the number of SSBs or in associated broadcast control channels.

Item 30. The method according to Item 28 or 29, wherein the control signaling comprises a flag indicative of the periodic sequence.

Item 31. The method according to any one of the Items 17 to 30, wherein the periodic sequence is preconfigured.

Item 32. The method according to any one of the Items 17 to 31, wherein the frequency resources are allocated in an unlicensed frequency spectrum.

Item 33. A network node comprising memory circuitry, processor circuitry, and a wireless interface, wherein the network node is configured to perform any of the methods according to any of Items 1-16.

Item 34. A wireless device comprising memory circuitry, processor circuitry, and a wireless interface, wherein the wireless device is configured to perform any of the methods according to any of Items 17-32.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that FIGS. 1-9 comprise some circuitries or operations which are illustrated with a solid line and some circuitries or operations which are illustrated with a dashed line. Circuitries or operations which are comprised in a solid line are circuitries or operations which are comprised in the broadest example. Circuitries or operations which are comprised in a dashed line are examples which may be comprised in, or a part of, or are further circuitries or operations which may be taken in addition to circuitries or operations of the solid line examples. It should be appreciated that these operations need not be performed in order presented. Furthermore, it should be appreciated that not all of the operations need to be performed. The example operations may be performed in any order and in any combination.

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the examples may be implemented at least in part by means of both hardware and software, and that several “means”, “units” or “devices” may be represented by the same item of hardware.

The various example methods, devices, nodes and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly, to be regarded in an illustrative rather than restrictive sense. The claimed disclosure is intended to cover all alternatives, modifications, and equivalents.

1. A method, performed by a network node, for transmission of a number of Synchronization Signal Blocks (SSBs) over a number of frequency resources to one or more wireless devices, wherein each SSB is associated with a corresponding beam, the method comprising:
broadcasting the SSBs according to a periodic sequence of frequency allocations for transmission of SSBs, wherein the periodic sequence has a period where a first frequency resource is allocated to a first SSB and a second frequency resource is allocated to a second SSB, wherein the second frequency resource and the first frequency resource are different.

2. The method according to claim 1, wherein the first SSB and second SSB are transmitted within the same SSB burst.

3. The method according to claim 2, wherein the first SSB and the second SSB are subsequent SSBs.

4. The method according to claim 1, wherein the periodic sequence indicates a staggering of the first SSB and the second SSB in frequency.

5. The method according to claim 1, wherein the first SSB belongs to a first SSB burst and the second SSB belongs to a second SSB burst, wherein the first SSB burst and the second SSB burst are different.

6. The method according to claim 5, wherein the first SSB burst and the second SSB burst are subsequent SSB bursts.

7. The method according to claim 5, wherein the periodic sequence indicates that the frequency allocations of the first SSB burst and the second SSB burst are staggered.

8. The method according to claim 1, wherein the periodic sequence comprises an ordered list of frequency resources from a set F={Fo, Fi, . . . Fi-i} of frequency resources, where I is the number of frequency resources.

9. The method according to claim 8, wherein the frequency resources in the ordered list are arranged in an ascending or descending order.

10. The method according to claim 8, wherein the ordered list of frequency resources is pseudo-randomized.

11. The method according to claim 1, the method comprising:
transmitting, to the one or more wireless devices, control signaling indicative of the periodic sequence of frequency allocation of the number of SSBs.

12. The method according to claim 11, wherein the control signaling indicative of the periodic sequence is comprised in one or more of the number of SSBs or in associated broadcast control channels.

13. The method according to claim 11, wherein the control signaling comprises a flag indicative of the periodic sequence.

14. The method according to claim 1, wherein the period of the periodic sequence is based on one or more of: the number of frequency resources and the number of SSBs in one SSB burst.

15. The method according to claim 1, wherein the periodic sequence is preconfigured.

16. The method according to claim 1, wherein the frequency resources are allocated in an unlicensed frequency spectrum.

17. A method, performed by a wireless device, for obtaining a number of Synchronization Signal Blocks (SSBs), the method comprising:
receiving, from a network node, a first SSB according to a periodic sequence of frequency allocations for transmission of SSBs, wherein the periodic sequence has a period where a first frequency resource is allocated to the first SSB and a second frequency resource is allocated to a second SSB, wherein the second frequency resource and the first frequency resource are different; and
determining the second frequency resource for receiving the second SSB based on the periodic sequence.

18. The method according to claim 17, wherein the method comprises:
monitoring the determined second frequency resource for the second SSB.

19. The method according to claim 17, wherein the first SSB and second SSB belong to the same SSB burst.

20. The method according to claim 19, wherein the first SSB and the second SSB are subsequent SSBs.

21-34. (canceled)
